(19) United States
(12) Patent Application Publication
(10) Pub. No.: US 2013/0083052 A1
(43) Pub. Date: Apr. 4, 2013

(54) METHOD FOR USING VIRTUAL FACIAL AND BODILY EXPRESSIONS

(71) Applicants: Erik Dahlkvist, Stockholm (SE); Martin Gumpert, Stockholm (SE); Johan van der Schoot, Bromma (SE)

(72) Inventors: Erik Dahlkvist, Stockholm (SE); Martin Gumpert, Stockholm (SE); Johan van der Schoot, Bromma (SE)

(21) Appl. No.: 13/434,970

(22) Filed: Mar. 30, 2012

Related U.S. Application Data
(63) Continuation-in-part of application No. 13/262,328, filed on Sep. 30, 2011.

(51) Int. Cl. G09G 5/00

(52) U.S. Cl. 345/619

(57) ABSTRACT

The method is for using a virtual face or body. The virtual face or body is provided on a screen associated with a computer system having a cursor. A user manipulates the virtual face or body with the cursor to show a facial expression. The communication device determines coordinates of the facial or bodily expression. The communication device searches for facial expression coordinates in a database to match the coordinates. A word or phrase is identified that is associated with the identified facial expression coordinates. The screen displays the word to the user. The user may also feed a word to the computer system that displays the facial expression associated with the word.

### PRIOR APPLICATIONS

This is a continuation-in-part application of U.S. patent application Ser. No. 13/262,328, filed 30 Sep. 2011.

### TECHNICAL FIELD

The invention relates to a method for using virtual facial and bodily expressions.

### BACKGROUND OF INVENTION

Facial expressions and other body movements are vital components of human communication. Facial expressions may be used to express feelings such as surprise, anger, sadness, happiness, fear, disgust and other such feelings. For some there is a need to train to better understand and interpret those expressions. For example, sales man, police and others may benefit from being able to better read and understand facial expressions. There is currently no effective method or tool available to train or study the perceptiveness of facial and body expressions. Also, in psychological and medical research, there is a need to measure subjects psychological and physiological reactions to particular, predetermined bodily expressions of emotions. Conversely, there is a need to provide subjects with a device for creating particular, named emotional expressions in an external medium.

### SUMMARY OF INVENTION

The method of the present invention provides a solution to the above-outlined problems. More particularly, the method is for using a virtual face or body. The virtual face or body is provided on a screen associated with a computer system that has a cursor. A user may manipulate the virtual face or body with the cursor to show a facial or bodily expression. The computer system may determine coordinates of the facial or bodily expression. The computer system searches for facial or bodily expression coordinates in a database to match the coordinates. A word or phrase is identified that is associated with the identified facial or bodily expression coordinates. The screen displays the word to the user. It is also possible for the user to feed the computer system with a word or phrase and the computer system will search the database for the word and its associated facial or bodily expression. The computer system may then send a signal to the screen to display the facial or bodily expression associated with the word.

### BRIEF DESCRIPTION OF DRAWINGS

FIG. 1 is a schematic view of the system of the present invention;

FIG. 2 is a front view of a virtual facial expression showing a happy facial expression of the present invention;

FIG. 3 is a front view of a virtual facial expression showing a surprised facial expression of the present invention;

FIG. 4 is a front view of a virtual facial expression showing a disgusted facial expression of the present invention;

FIG. 5 is a front view of a virtual face showing a sad facial expression of the present invention;

FIG. 6 is a front view of a virtual face showing an angry facial expression of the present invention;

FIG. 7 is a schematic information flow of the present invention;

FIGS. 8A and 8B are views of a hand;

FIGS. 9A and 9B are views of a body; and

FIGS. 10A, 10B and 10C are view of a face.

### DETAILED DESCRIPTION

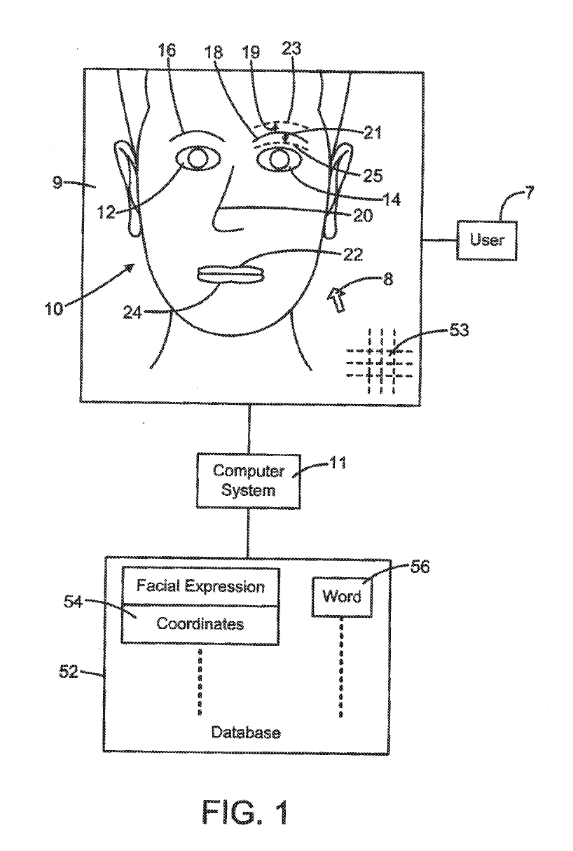

With reference to FIG. 1, the digital or virtual face 10 may be displayed on a screen 9 that is associated with a computer system 11 that has a movable mouse cursor 8 that may be moved by a user 7 via the computer system 11. The face 10 may have components such as two eyes 12, 14, eye brows 16, 18, a nose 20 an upper lip 22 and a lower lip 24. The virtual face 10 is used as an exemplary illustration to show the principles of the present invention. The same principles may also be applied to other movable body parts. A user may manipulate the facial expression of the face 10 by changing or moving the components to create a facial expression. For example, the user 7 may use the computer system 11 and point the cursor 8 on the eye brow 18 and drag it upwardly or downwardly, as indicated by the arrows 19 or 21 so that the eye brow 18 moves to a new position further away from or closer to the eye 14 as illustrated by eye brow position 23 or eye brow position 25, respectively. The virtual face 10 may be set up so that the eyes 12, 14 and other components of the face 10 also simultaneously change as the eye brows 16 and 18 are moved. Similarly, the user may use the cursor 8 to move the outer ends or inner segments of the upper and lower lips 22, 24 upwardly or downwardly. The user may also, for example, separate the upper lip 22 from the lower lip 24 so that the mouth is opened in order to change the overall facial expression of the face 10.

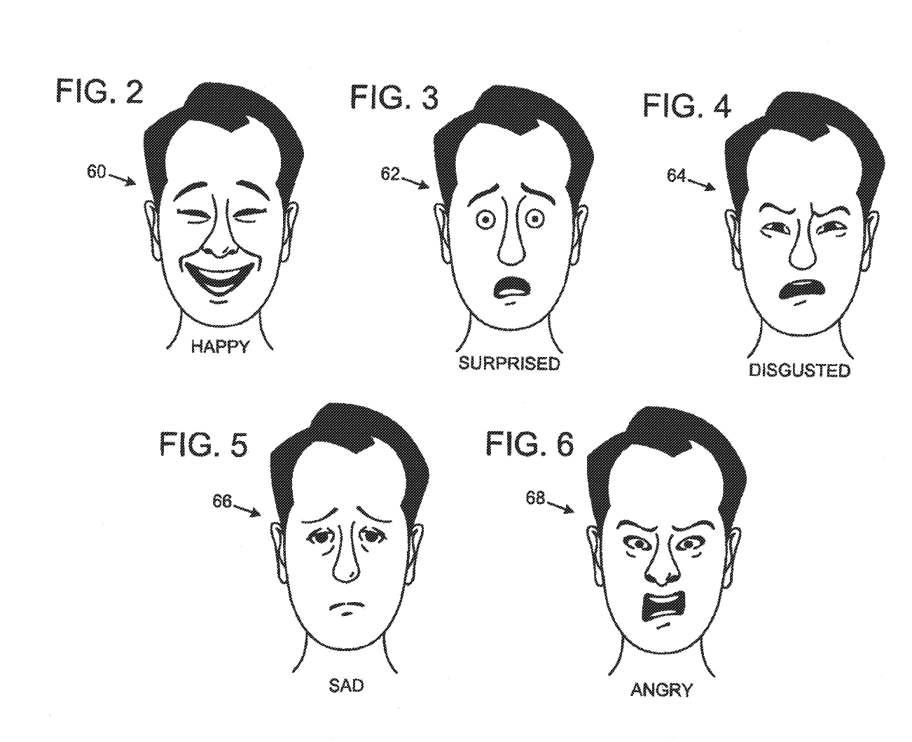

The coordinates for each facial expression 54 may be associated with a word or words 56 stored in the database 52 that describe the feeling illustrated by facial expressions such as happy, surprised, disgusted, sad, angry or any other facial expression. FIG. 2 shows an example of a happy facial expression 60 that may be created by moving the components of facial expression 62. FIG. 4 shows a disgusted facial expression 64. FIG. 5 shows a sad facial expresson 66 and FIG. 5 shows an example of an angry facial expression 68.

When the user 7 is complete the manipulating, moving or changing of the components, such as the eye brows, the computer system 11 reads the coordinates 53 (i.e. the exact position of the components on the screen 9) of the various components of the face and determines what the facial expression. The coordinates for each component may thus be combined to form the overall facial expression. It is possible that each combination of the coordinates of the facial expressions 54 of the components may have been pre-recorded in the database 52 and associated with a word or phrase 56. The face 10 may also be used to determine the required intensity of the facial expression before the user will see or be able to identify a certain feeling, such as happiness, expressed the facial expression. The user's time of exposure may also be varied and the number or types of facial components that are necessary until the user can identify the feeling expressed by the virtual face 10. As indicated above, the computer system 11 may recognize words communicated to the system 11 by the user 7. By communicating a word 56 to the system 11, the system preferably searches the database 52 for the word and locates the associated facial expression coordinates 54 in the database 52. The communication of the word 56 to the system 11 may be orally, visually, by text or any other suitable means of communication. In other words, the database 52 may include a substantial number of words and each word has a facial expression associated therewith that have been pre-recorded as pamphlets based on the positions of the coordinates of the movable components of the virtual face 10. Once the system 11 has found the word in the database 52 and its associated facial expression, the system sends signals to the screen 9 to modify or move the various components of the face 10 to display the facial expression associated with the word. If the word 56 is “happy” and this word has been pre-recorded in the database 52 then the system will send the coordinates to the virtual face 10 so that the facial expression associated with “happy” will be shown such as the happy facial expression shown in FIG. 2. In this way, the user may interact with the virtual face 10 of the computer system 11 and contribute to the development of the various facial expressions by pre-recording more facial expressions and words associated therewith.

It is also possible to reverse the information flow in that the user may create a facial expression and the system 11 will search the database 52 for the word 56 associated with the facial expression that was created by the user 7. In this way, the system 11 may display a word once the user has completed the movements of the components of the face 10 to create the desired facial expression. The user may thus learn what words are associated with certain facial expressions.

It may also be possible to read and study the eye movements of the user as the user sees different facial expressions by, for example, using a web camera. The user's reaction to the facial expressions may be measured, for example the time required to identify a particular emotional reaction. The facial expressions may also be displayed dynamically overtime so illustrate how the virtual face gradually changes from one facial expression to a different facial expression. This may be used to determine when a user perceives the facial expression changing from, for example, expressing a happy feeling to a sad feeling. The coordinates for each facial expression may then be recorded in the database to include even those expressions that are somewhere between happy expressions and sad expressions. It may also be possible to just change the coordinates of one component to determine which components are the most important when the user determines the feeling expressed by the facial expression. The nuances of the facial expression may thus be determined by using the virtual face 10 of the present invention. In other words, the coordinates of all the components, such as eye brows, mouth etc., cooperate with one another to together form the overall facial expression. More complicated or mixed facial expressions, such as a face with sad eves but a smiling mouth, may be displayed to the user to train the user to recognize or identify mixed facial expressions.

By using the digital facial expression of the present invention, it may be possible to enhance digital messages such as SMS or email with facial expressions based on words in the message. It may even be possible for the user himself/herself to include a facial expression of the user to enhance the message. The user may thus use a digital image of the user's own face and modify this face to express a feeling with a facial expression that accompanies the message. For example the method may include the step of adding a facial expression to an electronic message so that the facial expression identifies a word describing a feeling in the electronic message and displaying the feeling with the virtual face.

Cultural differences may be studied by using the virtual face of the present invention. For example, a Chinese person may interpret the facial expression different from a Brazilian person. The use may also use the user's own facial expression and compare it to a facial expression of the virtual face 10 and then modify the user's own facial expression to express the same feeling as the feeling expressed by the virtual face 10.

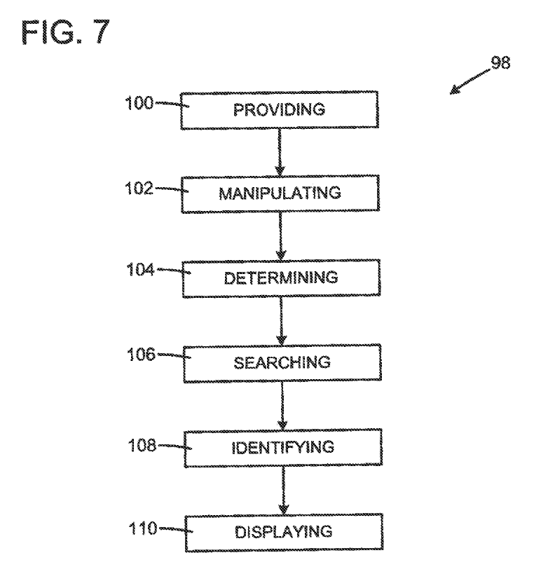

FIG. 7 illustrates an example 98 of using the virtual face 10 of the present invention. In a providing step 100, the virtual face 10 on the screen 9 associated with the computer system 11. In a manipulating step 102, the user 7 manipulates the virtual face 10 by moving components thereon such as eye brows, eyes, nose and mouth, with the cursor 8 to show a facial expression such as a happy or sad facial expression. In a determining step 104, the computer system 11 determines the coordinates 53 of the facial expression created by the user. In a searching step 106, the computer system 11 searches for facial-expression coordinates 54 in a database 52 to match the coordinates 53. In an identifying step 108, the computer system 11 identifies a word 56 associated with the identified facial expression coordinates 54. The invention is not limited to find just identifying a word but other expressions such as phrases are also included. In a displaying step 110, the computer system 11 displays the identified word 56 to the user 7.

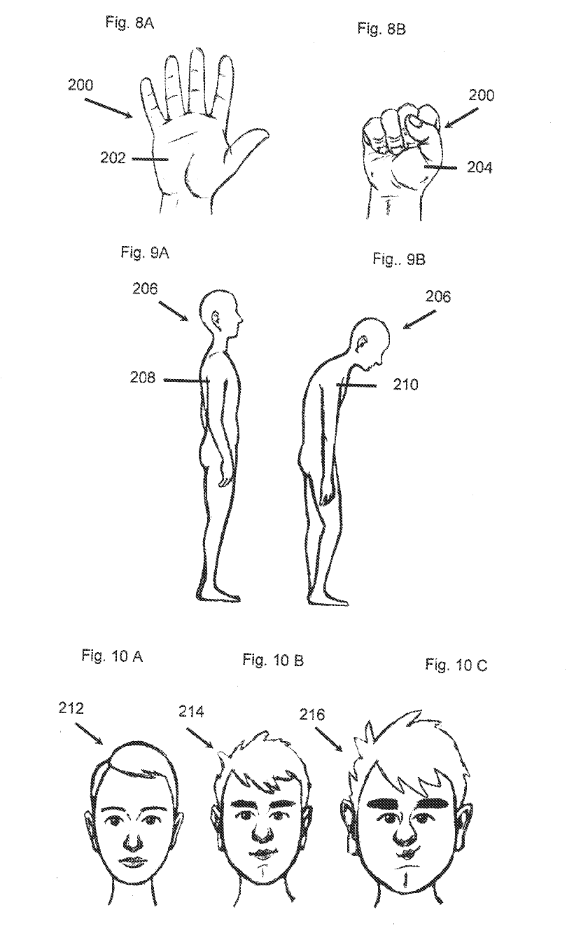

The present invention is not limited to computer systems but any communication device may be used including, but not limited, to telephones, mobile and smart phones and other such digitized display and communication devices. Also, the present invention is not limited to facial expressions. Facial expressions are only used as an illustrative example. Examples of other body or bodily expressions are in FIGS. 8-9. Bodily expressions together with facial expressions may be used although facial expressions are often most important. More particularly, FIG. 8A shows a hand 200 in an opened position 202 while FIG. 8B shows the hand 200 in a closed position 204 i.e. as a closed fist. FIG. 9A shows a body 206 in an erect position 208 while FIG. 9B shows the body 206 in a slumped position 210. FIGS. 10A-C show different facial expressions 212, 214 and 216 of a face that includes a mixture of different feelings. It is important to realize that the coordinates describing the face or body are movable so it is possible to create dynamic sequences of a dynamic expression coding system that may be used to describe different expressions of feelings. The coordinates are thus the active units in the virtual face or on the body that are moved to gradually change the expressions of feelings displayed by the face or body. The coordinates may be used for both two and three dimensional faces and bodies. Certain coordinates may be moved more than others and some coordinates are more important to display expressions of feelings when interpreted by another human being. For example, the movement of portions of the mouth and lips relative to the eyes are more important when expressing happiness compared to movements of coordinates on the outer end of the chin. One important aspect of the present invention is to register, map and define the importance of each coordinate relative to one another and the difference in importance when analyzing expressions. Not only the basic emotional expressions such as happiness, sadness, anger etc. but also expressions that mix several basic expressions are analyzed. Source codes of coordinates for expressions of feelings may be recorded in databases that are adjusted to different markets or applications that require the need for correct expressions of feelings such as in TV games, digital films or avatars on the Internet and other applications such as market research and immigration applications. It is important to realize that the present invention includes a way to create virtual human-beings that expresses a predetermined body language. This may involve different fields of coordinates that may be used to describe portions of a face or body. The field of coordinates related to the eye and mouth are different for different types of expressions. For example, the field of coordinates of the eye may show happiness while the field of coordinates of the mouth may show fear. This creates mixed expressions. The fields of coordinates are an important part of the measurements to determine which expression is displayed. A very small change of certain coordinates may dramatically change the facial expression as interpreted by other human-beings. For example, if all coordinates of a face remain the same but the eyebrows are rapidly lifted, the overall facial expression changes completely. However, a change of the position of the chin may not have the same impact.

It is possible to use a dynamic expression coding system to measure or produce predetermined dynamic and movable expressions of feelings. There are at least two options. A whole digital human-being, a digital face or body may be manipulated by using a cursor or pointer to obtain information about the expressions that are displayed. For example, the pointer may be used to lower the eyebrows and the level of aggression may be changed. It is also possible to obtain a description, such as in words or voice, of the expression displayed by the digital human being or face. It is also possible to add a command such as “happy” to the system a happy face or body is displayed. The dynamic movement, that is movement over time, may be obtained by moving the coordinates and their pre-programmed relationship to one another. In this way, the expressions may be displayed dynamically so that the expression is gradually changed from, for example, 20% happy to 12% sad. The dynamic changes may be pre-programmed so that the coordinates for each step in the change are stored in the database. The correct interpretation of each expression may be determined empirically to ensure correct communication between the receiver and sender. In other words, the user may slightly change the facial or bodily expression by changing a command from, for example, 20% happy to 40% happy. Based on empirical evidence, the system of the present invention will change the expression so that the face looks more happy i.e. 40% happy instead of just 20% happy to most other human beings. This interactive aspect of the invention is important so that the user may easily change the facial expression by entering commands or the system may easily interpret a facial expression by analyzing the coordinates on the virtual face or body and then provide a description of the facial expression by searching in the database for the same or similar coordinates that have been pre-defined as describing certain facial or bodily expressions. The database may thus include facial or bodily coordinates that are associated or matched with thousands of pre-recorded facial or bodily expressions. The pace of the change may also be important. If the change is rapid it may create a stronger impression on the viewer so that the face looks more happy compared to a very slow change. It is also possible to start with the facial expression and have the system interpret it and then provide either a written or oral description of the facial expression. The coordinates may thus be used to not only help the viewer interpret a facial expression by providing a written or oral description of the facial expression but also be used to create a facial or bodily expression based on written or oral commands such as “Create a face that shows 40% happiness.” The system will thus analyze each coordinate in the face and go into the database to determine which pre-stored facial expression best matches the facial expression that is being displayed based on the position of the coordinates in the virtual face compared to the coordinates in the pre-stored facial expression. The database thus includes information for a large variety of facial expression and the position of the coordinates for each facial expression. As a result, the system may display a written message or description that, for example, the face displays a facial expression that represents 40% happiness. As indicated above, the coordinates are dynamic and may change over time similar to a short film. In this way, the facial 10% expression may, for example, change from just 10% happy to 80% happy by gradually moving the coordinates according to the coordinate information stored in the database.

While the present invention has been described in accordance with preferred compositions and embodiments, it is to be understood that certain substitutions and alterations may be made thereto without departing from the spirit and scope of the following claims.

1. A method for using a virtual face and body, comprising:
providing a virtual face and body on a screen associated with a communication device;
dragging a component of the virtual body from a first position to a second position to change the virtual body from having the first expression to a second expression, the second expression being different from the first expression;
the communication device recognizing the second expression and identifying an expression in a database that matches the second expression;
identifying a first word associated with the identified expression,
changing the first word to a second word, the second word being different from the first word,
the communication device searching the database for the second word and identifying coordinates of a third expression associated with the second word, and
the communication device moving components of the second expression to gradually change the second expression to display the third expression associated with the second word.

2. The method according to claim 1 wherein the method further comprises the steps of pre-recording words describing facial expressions in the database.

3. The method according to claim 2 wherein the method further comprises the steps of pamphlets of facial expression coordinates of facial expressions in the database and associating each facial expression with the pre-recorded words.

4. The method according to claim 1 wherein the method further comprises the steps of feeding the word to the communication device, the communication device identifying ire a word in the database associating the word with a facial expression associated with the word in the database.

5. The method according to claim 4 wherein the method further comprises the steps of the screen displaying the facial expression associated with the word.

6. The method according to claim 1 wherein the method further comprises the steps of training a user to identify facial expression.

7. The method according to claim 1 wherein the method further comprises the steps of adding a facial expression to an electronic message so that the facial expression identifies a word describing a feeling in the electronic message and displaying the feeling with the virtual face.
